(19) United States
(12) Patent Application Publication
(10) Pub. No.: US 2013/0313263 A1
(43) Pub. Date: Nov. 28, 2013

(54) Self draining salad bowl

(71) Applicant: Nader Kuroush Parsia, Kaunakakai, HI (US)

(72) Inventor: Nader Kuroush Parsia, Kaunakakai, HI (US)

(21) Appl. No.: 13/506,939

(22) Filed: May 24, 2012

(51) Int. Cl. A47J 43/00; B65D 1/34

(52) U.S. Cl. 220/571

(57) ABSTRACT

Self Draining Salad Bowl in the present invention and its' function includes a bowl member, a cover member and a receptacle member. When salads are placed in the bowl a convex dome at the base of the bowl member helps to elevate the salad to separate fluids and then gravity further assists releasing all liquids to drip down towards the base of the bowl where several draining holes are situated. All excess liquids from salads will drain onto a receptacle member placed under the bowl, and thus the contents in the bowl will stay crispy and will not become soggy and not wasted. These features will maintain the salad's original fresh, delicious taste; the drained liquid in the receptacle may be saved, reused or disposed. The bowl may be covered, then kept in the refrigerator, to maintain the salad fresh for longer periods of time.

### BRIEF DESCRIPTION OF THE DRAWINGS

FIG. 1 is a perspective view of a self draining bowl assembly according to one embodiment of the present invention;

FIG. 2 is a side view of the self draining bowl assembly of FIG. 1;

FIG. 3 is an exploded perspective view of the self draining bowl assembly of FIG. 1 with the cover removed;

FIG. 4 is an exploded cross-sectional view of the self draining bowl assembly of FIG. 1 with the cover removed; and

FIG. 5 is a view through line 5-5 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a self draining salad bowl assembly. Salad and fruit salad can become soggy due to excess moisture in the bowl. Embodiments of the present invention can provide a salad bowl having a drainage system. Embodiments of the present invention can prevent the salad from becoming soggy and may help keep it fresh by allowing liquids to drain from the bowl and capturing the drained liquids.

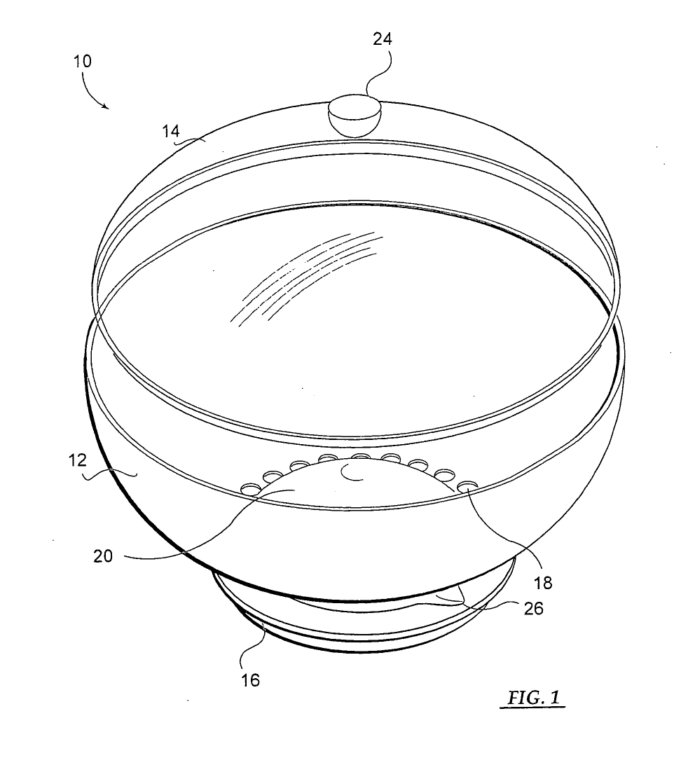

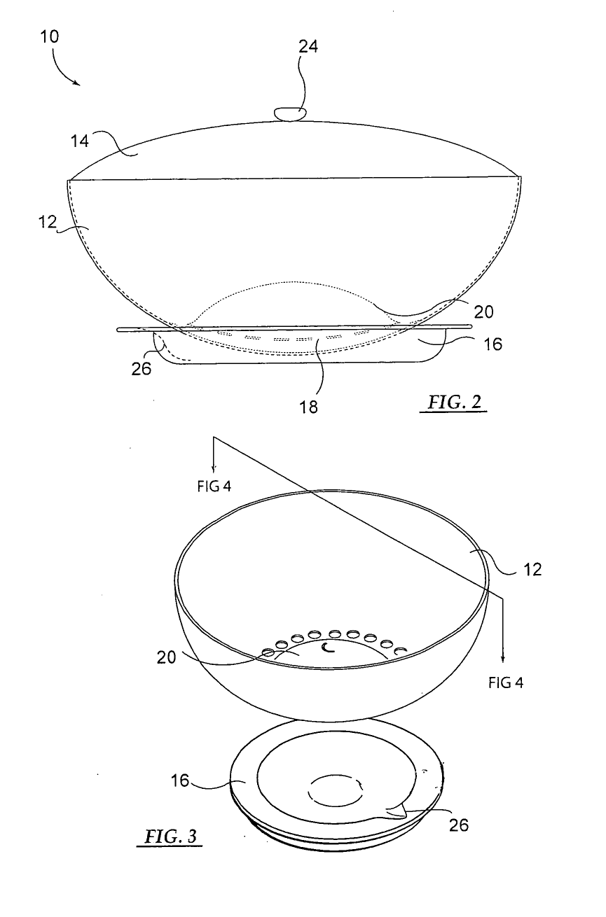

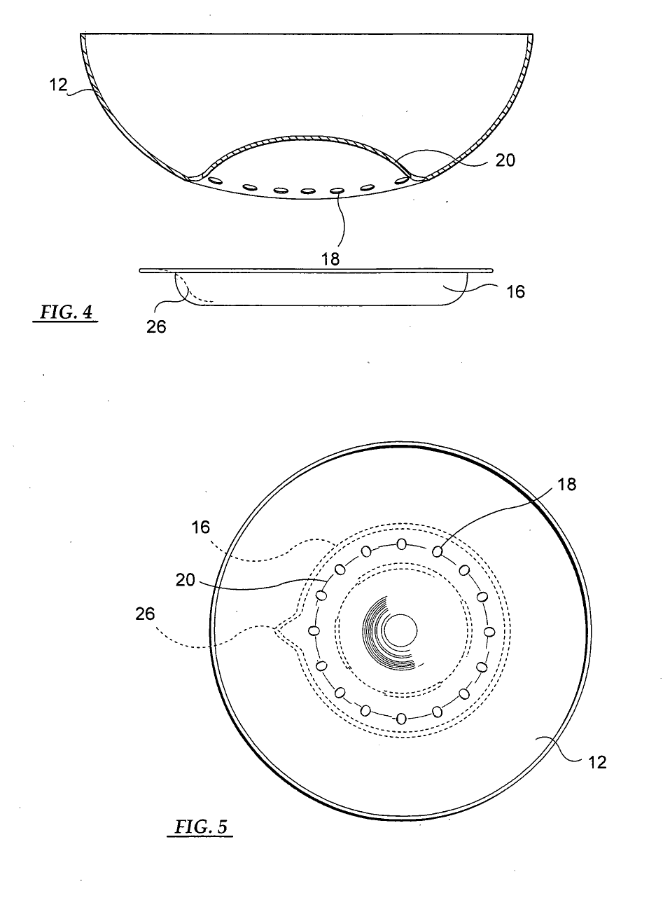

A self draining salad bowl assembly 10 according to an embodiment of the present invention is shown in FIGS. 1-5. The self draining salad bowl assembly 10 may include a bowl member 12, a cover member 14, and a drip receptacle member 16.

The bowl member 12 may comprise a structure designed to hold a salad (not shown) and may include a plurality of drainage openings 18. For some embodiments, the bowl member 12 may include a convex bottom portion 20. The convex bottom portion 20 may direct liquids from the salad towards the drainage openings 18. The drainage openings 18 may extend through the bowl member 12 and may allow liquids to flow from the salad to the drip receptacle member 16.

For some embodiments, the bowl member 12 may include at least one handle/vent 22. The handle/vent 22 may comprise a spout shaped structure designed to allow air to circulate around the salad when the cover member 14 is positioned on the bowl member 12. The increased air circulation provided by the handle/vent 22 may help maintain salad freshness. Additionally, the handle/vent 22 may be used to grasp the bowl member 12 for ease of use.

For some embodiments, the bowl member 12 may comprise materials including wood, plastic and metal. The dimensions of the bowl member 12 may vary and may depend on factors including the application and the composition of the bowl member 12. For some embodiments, the bowl member 12 may comprise a round bowl structure having a diameter of about 12 inches and a height of about 5.5 inches. For some embodiments, the height of the convex bottom portion 20 may be about 3 inches.

The cover member 14 may be designed to be removable and designed to fit on the bowl member 12. The cover member 14 may be removably in contact with the bowl member 12. For some embodiments, the cover member 14 may include a knob 24 for ease of use. The cover member 14 may comprise a material, such as plastic, glass, ceramic and metal. The dimensions of the cover member 14 may vary with application and may depend on factors including the dimensions of the bowl member 12. For some embodiments, the cover member 14 may have a diameter of about 12 inches and a height of about 2 inches.

The drip receptacle member 16 may be designed to be positioned under the bowl member 12 and designed to catch liquid from the salad that passes through the drainage openings 18. The drip receptacle member 16 may be removably in contact with the bowl member 12. For some embodiments, the drip receptacle member 16 may include a pour spout 26. The pour spout 26 may be used to empty the drip receptacle member 16. For some embodiments, the drip receptacle member 16 may include a central opening 28 (see FIG. 3) designed to help hold the bowl member 12 in place.

Embodiments of the present invention can help prevent salads/fruit salads from becoming wet, soggy, and slimy so that the salads remain dry & crispy. Embodiments of the present invention may capture the drained liquid from the bowl member 12 so that the drained liquid can be discarded or reserved for later use.

It should be understood, of course, that the foregoing relates to exemplary embodiments of the invention and that modifications may be made without departing from the spirit and scope of the invention as set forth in the following claims.

What is claimed is:

1. A self draining salad bowl assembly for salad comprising:
a bowl member having a plurality of drainage openings,
a cover member removably in contact with said bowl member, and
a drip receptacle member removably in contact with the said bowl member.

2. A bowl member as claimed in claim 1, having a convex bottom portion, the purpose of which is to direct liquids to the drainage openings.

3. (canceled)

4. A drip receptacle member claimed in claim 1, having a pour spout having the purpose of empting the liquid from said drip receptacle member.

5. (canceled)

6. A drip receptacle member claimed in claim 1, having a position under the salad bowl for the purpose of supporting said salad bowl.
